(19) United States
(12) Patent Application Publication
(10) Pub. No.: US 2007/0181018 A1
(43) Pub. Date: Aug. 9, 2007

(54) Rotary element of a printing press, having an encoder and a synthesizer

(75) Inventors: Alain Colin, Lamorlaye (FR); Emmanuel Lebeuf, Sainte Maxence (FR); Yves Caulier, Montataire (FR)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Montataire SA, Montataire (FR)

(21) Appl. No.: 10/588,807

(22) PCT Filed: Feb. 14, 2005
(86) PCT No.: PCT/IB05/00350

§ 371 Date: Aug. 7, 2006

(30) Foreign Application Priority Data
Feb. 13, 2004 (DE) 10 2004 007 069.5

(51) Int. Cl. B41F 5/00

(52) U.S. Cl. 101/216

(57) ABSTRACT

A rotary element of a printing press is provided, in particular in a folding apparatus of the printing press, including an encoder for generating a first periodic signal in response to rotation of the rotary element, the encoder being linked to an evaluation unit which has at least one synthesizer for generating a second signal having a resolution ratio, a frequency ratio, and a phase relation to the first signal. The possible uses of the signal generated by the encoder in response to the rotation of the rotary element are expanded and rendered flexible.

### BACKGROUND

The present invention is directed to a rotary element of a printing press, having an encoder for generating a first periodic signal in response to rotation of the rotary element.

In printing presses, in particular offset presses and folding apparatuses of rotary offset presses, the angular position, the angular velocity or the angular acceleration of a rotating element, a rotating assembly or of a rotary element, for example of a cylinder or of a roller, is measured and converted by an encoder into an electrical signal. The signal is periodic in the sense that the rotational motion is periodic, but in various forms, in particular analog or digital, it can be a measure for the measured quantity. It is clear that, when the rotation is irregular, the signal will also exhibit a variable periodicity. The purpose of determining a quantity that is characteristic of the rotation of a rotary element is, in particular, to generate clock signals for controlling or regulating other devices, in particular measuring devices, assemblies, other rotary elements or the like. For the sake of simplicity of this description, all conceivable receivers of such clock signals are merely described in the following as clock-pulse-controlled devices.

When it is intended for a plurality of different clock signals to be generated for a plurality of clock-pulse-controlled devices, the logical procedure that comes immediately to mind and that is also customary in practice, is to use a plurality of signals produced by a plurality of (mutually independent) encoders, which each generate a periodic signal in response to rotation of the rotary element, and to direct the thus obtained clock signals to the clock-pulse-controlled devices (parallel processing). What can be restrictive about this approach is that the space requirement for a plurality of encoders, in particular for their sensors, measuring sensors, or transducer elements, is substantial and is not always readily available. Also, each encoder typically has a fixed resolution, i.e., measured values or signal elements per period, a fixed transmission ratio (frequency ratio) to the period of the rotary element, i.e., either the ratio of the periods of the encoder to the rotation of the rotary element is an integer number or the reciprocal of the ratio is an integer number, and has a fixed phase relation to the angular position or to the azimuth of the rotary element, so that only fixed clock signals can be generated as a function of the rotation.

In the context of printing presses, it is also already known to further process a signal received from an encoder in an electronically secure form. From the prior German Patent Application no. DE 103 51 218.7, for example, a circuit and a method are known for processing an input signal having a first resolution (represented in said document by the frequency of the signal) into at least one output signal having a second resolution and the same phase as the input signal. A thus produced higher resolution for a clock signal is necessary, for example, for the resolution of an imaging device which cooperates with the rotary element in such a way that it is coordinated with the rotation of the latter, in order to image a printing form accommodated on the rotary element. The circuit described in the document in question is optimized to the special requirements of that particular application, so that the described technical teaching cannot be used for other purposes without modifications thereto.

### BRIEF SUMMARY OF THE INVENTION

An object of the present invention is to expand and/or render flexible the possible uses of a signal generated by an encoder in response to the rotation of a rotary element.

A rotary element according to the present invention, of a printing press, thus in a printing press, includes an encoder for generating a first periodic signal in response to rotation of the rotary element, and an evaluation unit that is linked to the encoder and that has at least one synthesizer for generating a second signal having a resolution ratio, a frequency ratio, and a phase relation to the first signal. The rotary element may also be described as a rotating element, a rotating member, or as a rotating assembly. The rotary element rotates, in particular, about an axis extending through the rotary element, for example an axis of reflection or an axis of symmetry. An occurrence of or a change in the first signal leads in the evaluation unit to an occurrence of or a change in the second signal, thereby resulting in a response characterized by the specified parameters. In this manner, it may be advantageously possible for a second signal to be generated which overcomes the mentioned limitations of the first signal which are conditional upon the encoder that is used.

The periodic signal may be analog or digital, in particular, it may be composed of individual elements or of a sequence of elements. The synthesizer may also be described as a frequency synthesizer or as an encoder synthesizer. The frequency ratio may also be described as a transmission ratio, i.e., as the period ratio of the second signal to the first signal and, in particular, may be one. The phase relation may be 0 to 2π, for example. The resolution may be encoded at a high frequency in the periodic signal, so that a specific number of high-frequency periods reside in the mentioned period (with respect to the rotation of the rotary element).

The evaluation unit may also be provided with a control interface to the data exchange, so that the resolution ratio and/or frequency ratio and/or the phase relation of the first and second signal is adjustable or selectable on the basis of data transmitted for the synthesizer. In this manner, the flexibility of the second signal made possible by the evaluation unit may even be utilized to effect a rapid change in the parameters in order to change the second signal.

The evaluation unit may be provided with at least one output interface, preferably with a plurality of output interfaces, via which the second signal may be output for driving a clock-pulse-controlled device.

In one preferred embodiment of the rotary element according to the present invention, the resolution of the second signal of the evaluation unit may be smaller than that of the first signal.

One embodiment may provide for the evaluation unit to have at least one divider device connected upstream of the synthesizer, in particular for divisions by two or four, to reduce the resolution of the decoded first signal. Alternatively thereto, the embodiment may also be such that the divisor is selectable. Thus, when the first signal has a high resolution, the required processing speed of the synthesizer may be lower. In one alternative embodiment, an upstream multiplication device may also be provided, which makes it possible to increase the resolution of the decoded first signal.

In individual specific embodiments, the first and the second signals may in each instance be a sequence of signal pulses, a sequence of digital values (bits, bytes, words), or a variable analog value. When the encoder has a plurality of pulse tracks, i.e., it generates in parallel a plurality of measurement signals, for example measurement signals in quadrature form, the first signal may be a signal that is derived from these measurement signals or one of the plurality of measurement signals.

The rotary element according to the present invention may be for example, a shaft, a cylinder, a roller, a reel, a cylinder journal, or a gear wheel.

Especially preferred may be an embodiment of the rotary element having an evaluation unit, which includes a plurality of synthesizers for generating a plurality of signals, each having a resolution ratio, a frequency ratio, and a phase relation to the first signal, the resolution ratios, and/or the frequency ratios and/or the phase relations of two signals of the plurality of signals being different. In this way, from one encoder signal, it is advantageously possible to flexibly or variably generate a plurality of clock signals for clock-pulse-controlled devices.

A printing press, in which a rotary element according to the present invention is used, may, in particular, be a rotary offset press. A printing press of this kind, whether it be for commercial printing or for newspaper printing, may include at least one folding apparatus. In addition, a rotary offset press may include at least one reel changer, a number of printing units, typically four printing units, which print on both sides of a web substrate, and a dryer. In other words, a folding apparatus in accordance with the present invention of a rotary offset press may be distinguished by at least one rotary element in accordance with this specification.

A printing press, in which a rotary element according to the present invention is used, may be a web-fed or a sheet-fed press. In particular, the printing press may be a lithographic press, a direct or indirect planographic press, or an offset press. In other words, an offset press in accordance with the present invention may be characterized by at least one rotary element in accordance with this specification.

### BRIEF DESCRIPTION OF THE DRAWINGS

Further advantages, advantageous embodiments and refinements of the present invention are described with reference to the following figures, as well as their descriptions. Specifically, they show:

FIG. 1 a schematic representation of the topology of one embodiment of a rotary element according to the present invention;

FIG. 2 a schematic for illustrating one preferred embodiment for generating clock signals in a folding apparatus of a printing press; and

FIG. 3 a schematic representation of the evaluation unit in one preferred specific embodiment of the rotary element according to the present invention.

### DETAILED DESCRIPTION OF THE PREFERRED EMBODIMENTS

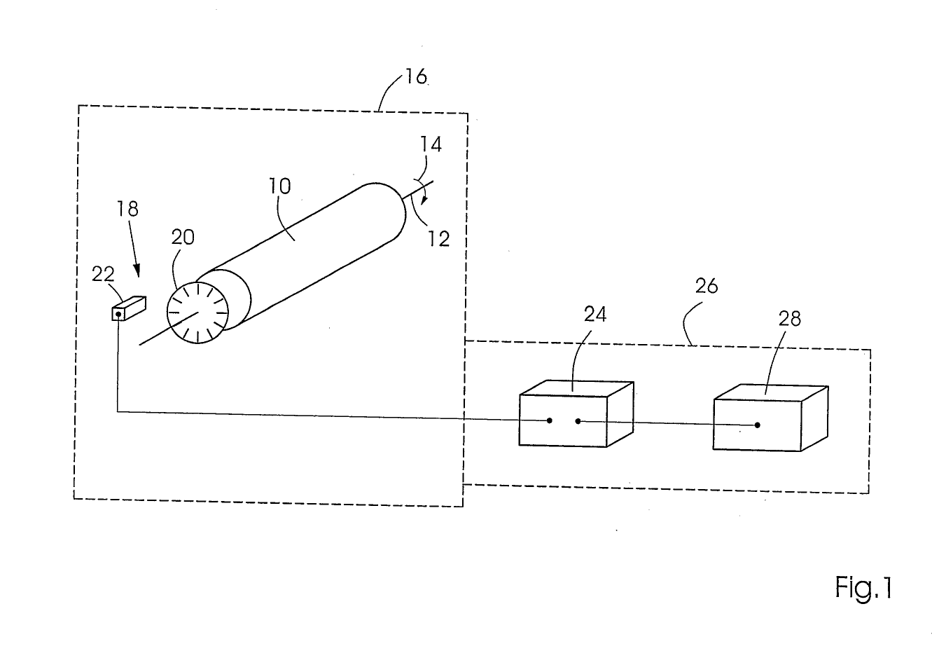

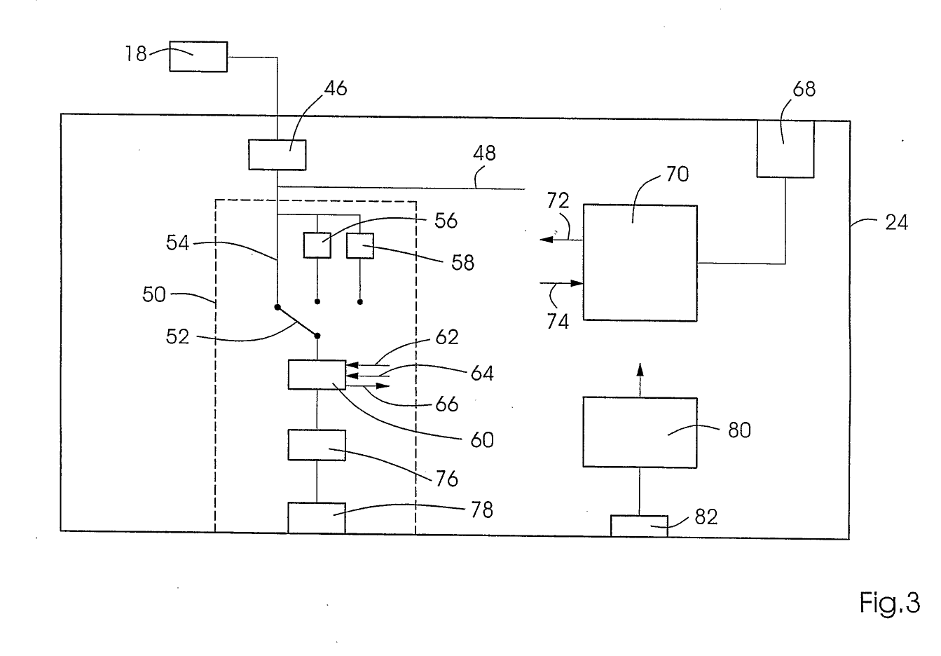

FIG. 1 is a schematic representation of the topology of one embodiment of a rotary element according to the present invention. In this specific embodiment, a rotary element 10 according to the present invention is a cylinder, which is rotatably accommodated in a printing press 16 about an axis of rotation 12 in direction of rotation 14. Located on one journal of rotary element 10 is an encoder 18, implemented here as an encoder disk 20 on axis of rotation 12, whose encoding pattern, in this case a number of subdivision marks arranged azimuthally on encoder disk 20, are measured by an encoder sensor 22 and converted into an electrical signal. To the extent that the rotation of rotary element 10 is periodic, the electrical signal is also periodic. Typically, a special encoding is provided for an angular reference position (zero position), or the encoding pulses are counted until the number occurring in response to one full revolution is reached. However, any type of encoder may be used. Encoder 18 is linked to an evaluation unit 24 in a control unit 26 of printing press 16. Evaluation unit 24 also ensures that encoder 18 is supplied with electrical power via the shared connection. In evaluation unit 24, as is explained in greater detail, in particular with reference to FIG. 3, a synthesizer 60 may be used to generate from the periodic signal, a second signal having a resolution ratio, a frequency ratio, and a phase relation to the periodic signal. Control unit 26 includes an input device 28, for example a web server computer, so that parameters for evaluation unit 24 may be changed or set by a machine operator. A change or setting may be effected as a presetting or as a control during a production in progress.

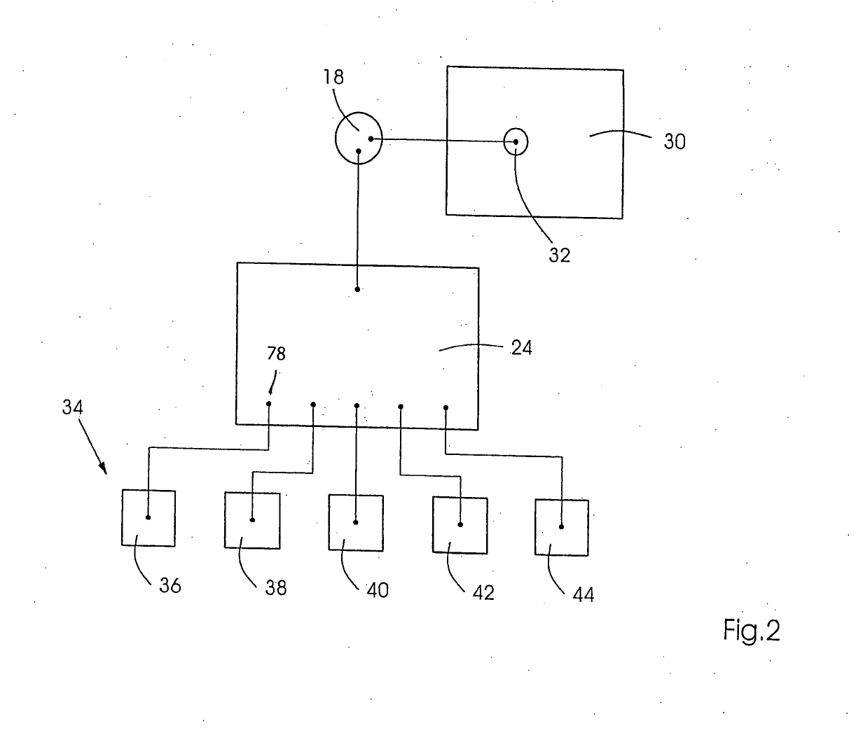

FIG. 2 schematically illustrates one preferred embodiment for generating clock signals in a folding apparatus of a printing press. In the context of this description of the present invention, a folding apparatus is always considered as part of a printing press, in particular of a rotary offset press. A folding apparatus 30 has a cutting cylinder 32, in particular for cutting off signatures or sheets from a web substrate printed on in the upstream printing units. In this preferred specific embodiment, cutting cylinder 32 constitutes rotary element 10 according to the present invention, having an encoder 18 whose topology was elucidated above with reference to FIG. 1. Encoder 18 may be described as a master encoder for the folding apparatus. Preferably, this encoder 18 has a high resolution for the full circle of 2π, for example, 4,096 pulses per revolution, given approximately 15,000 revolutions per minute. Encoder 18 is linked to evaluation unit 24. Evaluation unit 24, which is clarified in greater detail with reference to FIG. 3, has a plurality of output interfaces 78, preferably ten, of which five are shown here, to which clock-pulse-controlled devices 34 are connected.

In accordance with the present invention, at each of output interfaces 78, evaluation unit 24 supplies variably and flexibly, and mutually independently, one signal each having a different resolution, different frequency and different phase than those of the signal generated by encoder 18. For that reason, the signals of output interfaces 78 may be described as virtual encoder signals; evaluation unit 24 represents a number of virtual encoders. These virtual encoders may be conveniently and quickly installed, modified or controlled by making parameter adjustments, while expending little outlay and without the need for the press operator to make mechanical modifications. In one preferred embodiment, using the signals at each of its output interfaces 78, evaluation unit 24 may output encoder values between two and maximally available pulses per revolution, in this case 4,096 pulses. 5 VDC, 24 VDC or 10/30 VDC encoders may be electronically emulated, simulated or represented. As already mentioned, a transmission ratio or frequency ratio may also be provided: For example, for two or more rounds or revolutions of the master encoder, one round or one revolution of a virtual encoder may be produced in evaluation unit 24.

In the embodiment shown in FIG. 2, the following clock-pulse-controlled devices are connected to evaluation unit 24. A redundancy encoder 36 receives 2,048 pulses per revolution (24 VDC). A stroboscope 38 receives 512 pulses per revolution (24 VDC). A register control 40 receives 2,048 pulses per revolution (5 VDC). A color control 42 receives 2,048 pulses per revolution (5 VDC). A glue application system 44 receives 2,000 pulses per revolution (24 VDC).

FIG. 3 schematically represents evaluation unit 24 in one preferred embodiment of rotary element 10 according to the present invention. Evaluation unit 24 has an incremental input and a plurality of incremental outputs. From encoder 18, a first signal arrives in evaluation unit 24, initially in a four-phase decoder 46, so that the decoded signal is present on a signal line 48, in other specific embodiments, also on a plurality of signal lines (for example, INC, DEC or CLR lines). The signal line branches off into a number of functional units 50, only one being shown in FIG. 3 for the sake of simplicity. Preferably, the evaluation unit has ten such functional units 50.

To begin with, functional unit 50 includes a switch 52, which, as indicated by the double arrow, makes it possible to switch among a direct line 54, a divider device 56 for dividing by factor two, and a divider device 58 for dividing by factor four. The decoded signal is fed to a synthesizer 60, so that, as a function of the clock pulse frequency preset by encoder 18 and the phase preset by encoder 18, synthesizer 60 may generate a second signal having a specific resolution ratio, a specific frequency ratio, and a specific phase relation to the signal of encoder 18. Information on the required or desired resolution 62 and the required or desired phase shift 64 is fed to synthesizer 60, in particular by variably inputting the same into a control unit (see also FIG. 1). Position 66 of the second signal, i.e., its current phase angle, is made available by synthesizer 60 for monitoring purposes.

The parameters of each synthesizer 60 of each functional unit 50 may be set or changed as clarified with reference to FIG. 1, via an input device 28, for example a web server. For this purpose, evaluation unit 24 has a control interface 68, in particular an ethernet interface, for example an RS232 interface. Evaluation unit 24 also has a data memory 70, in this specific embodiment an 8 MByte memory. From this data memory 70, setting values 72 may be fed to respective synthesizer 60, positional values 74 supplied by each of synthesizers 60 arrive in data memory 70. The contents of data memory 70 may also be written or read remotely by an input device 28. A suitable computer program exists for parameterizing, monitoring, and diagnosing evaluation unit 24.

In each of functional units 50, the second signal generated by the particular synthesizer 60 is fed to an amplifier 76 before being sent to an output interface 78. Amplifier 76 may have an electronic 5V-RS422 unit, a 24V push-pull unit, or a 10-30V PNP unit, or also a unit selectable among these.

Evaluation unit 24 has an electric power supply 80 for supplying different voltages, in particular +5V and +3.8V.±24V d.c. current is available at supply interface 82 of electric power supply 80.

Although in this specification, evaluation unit 24, which virtually generates a number of encoder signals, is described in the context of a rotary element 10, it is clear to one who is skilled in the art and for whom this technical teaching is relevant, that evaluation unit 24 may also be used in accordance with the present invention with an encoder for recording a linear motion of an element or the position of a linearly movable element (assembly or member).

### REFERENCE NUMERAL LIST

10 rotary element
12 axis of rotation
14 direction of rotation
16 printing press
18 encoder
20 encoder disk
22 encoder sensor
24 evaluation unit
26 control unit
28 input device
30 folding apparatus
32 cutting cylinder
34 clock-pulse-controlled devices
36 redundancy encoder
38 stroboscope
40 register control
42 color control
44 glue application system
46 four-phase decoder
48 signal line
50 functional unit
52 switch
54 direct line
56 divider device factor two
58 divider device factor four
60 synthesizer
62 resolution
64 phase shift
66 position
68 control interface
70 data memory
72 setting values
74 positional values
76 amplifier
78 output interface
80 electric power supply
82 supply interface

1-10. (canceled)

11. A rotary element of a printing press comprising:
an encoder for generating a periodic first signal in response to rotation of the rotary element; and
an evaluation unit linked to the encoder having at least one synthesizer for generating a second signal having a resolution ratio, a frequency ratio, and a phase relation to the first signal.

12. The rotary element as recited in claim 1 wherein the evaluation unit includes a control interface for data exchange, the control interface adjusting or selecting at least one of the resolution ratio, the frequency ratio and the phase relation of the first and second signal based on data transmitted from the synthesizer.

13. The rotary element as recited in claim 1 wherein the evaluation unit includes at least one output interface, the output interface outputting the second signal for driving a clock-pulse-controlled device.

14. The rotary element as recited in claim 1 wherein a resolution of the second signal is smaller than a resolution of the first signal.

15. The rotary element as recited in claim 1 wherein the evaluation unit includes at least one divider device connected upstream of the synthesizer for reducing a resolution of the first signal in a decoded state.

16. The rotary element as recited in claim 1 wherein the first and the second signals each are a sequence of signal pulses, a sequence of digital values, or a variable analog value.

17. The rotary element as recited in claim 1 wherein the rotary element is a shaft, a cylinder, a roller, a reel, a cylinder journal, or a gear wheel.

18. The rotary element as recited in claim 1 wherein the evaluation unit includes a further synthesizer for generating a further signal, the further signal having a further resolution ratio, a further frequency ratio, and a further phase relation to the first signal, at least one of the further resolution ratio or the further frequency ratio or the further phase relation of the further signal being different from the resolution ratio, frequency ratio or phase relation, respectively, of the second signal.

19. A folding apparatus of a rotary offset press comprising at least one rotary element as recited in claim 1.

20. An offset press comprising at least one rotary element as recited in claim 1.
